(19) United States
(12) Patent Application Publication
(10) Pub. No.: US 2005/0078005 A1
(43) Pub. Date: Apr. 14, 2005

(54) Replacement indicator

(76) Inventor: Carl D. Contadini, Terryville, CT (US)

Correspondence Address: Arthur G. Schaier;Carmody & Torrance LLP, 50 Leavenworth Street, P.O. Box 1110, Waterbury, CT, 06721-1110, US

(21) Appl. No.: 10/686,209

(22) Filed: Oct. 14, 2003

(51) Int. Cl. G08B 21/00

(52) U.S. Cl. 340/540; 340/636.1; 340/641; 340/309.16

(57) ABSTRACT

The present invention describes a system for determining the effectiveness of a consumable source in a device that uses the consumable source to perform an action of the device. The system comprising a controller for monitoring the consumable source in the device, a consumable source operatively connected to the device, sensing means for determining when the consumable source needs replacing; and an indicator operatively coupled to the sensing means that signals when the replaceable source needs replacing.

### BACKGROUND OF THE INVENTION

Many devices contain consumable sources, such as lights, adhesive papers, etc. that are used to perform various functions in the device. For example, a hand dryer may contain a germicidal tube for sterilizing air in the dyer. Over time, the germicidal tube may lose its effectiveness and thus require replacement.

Insect traps, such as described in U.S. Pat. No. 5,915,948, the subject matter of which is herein incorporated by reference in its entirety, may contain an adhesive paper for immobilizing insects as well as UV lights for attracting insects to the trap, both of which require periodic replacement to continue to perform effectively.

Many of these devices of the prior art d not contain any indicator for alerting the user that the device is not functioning up to its optimal level. In many instances, a user must remember when the consumable source was last replaced or be reminded by the device failing to function properly.

While sensors have been used in the past to monitor performance of such devices, there remains a need in the art for a system that will both monitor the state of the consumable source in the device and alert the user that the consumable source needs replacement.

The present invention comprises a new system for determining the effectiveness of a consumable source in a device that uses the consumable source to perform an action of the device.

### SUMMARY OF THE INVENTION

The present invention describes a system for determining the effectiveness of a consumable source in a device that uses the consumable source to perform an action of the device, the system comprising:
a controller for monitoring the consumable source in the device;
a consumable source operatively connected to the device;
sensing means for determining when the consumable source needs replacing; and
an indicator operatively coupled to the sensing means that signals when the replaceable source needs replacing.

### BRIEF DESCRIPTION OF THE DRAWINGS

FIG. 1 is a diagram of the replacement indicator of the invention.

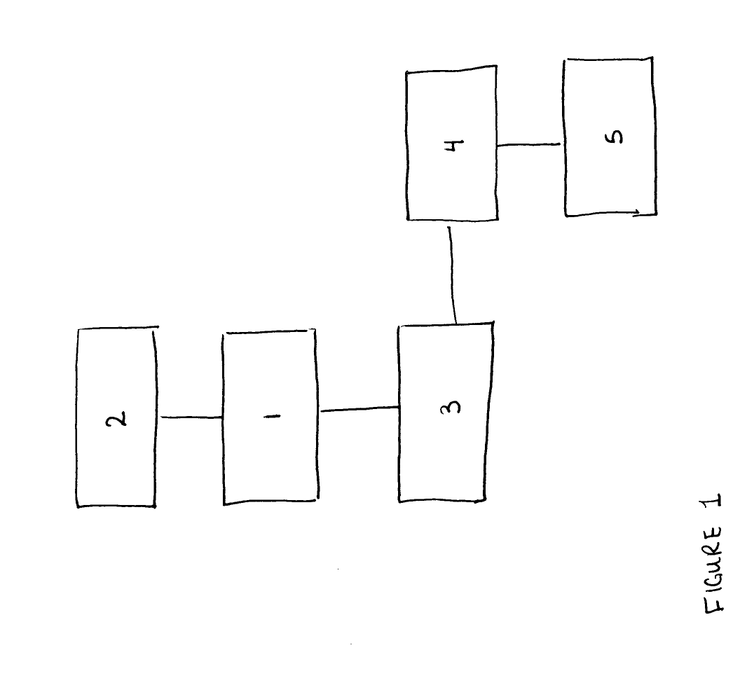

FIG. 2 describes one embodiment of the invention as the replacement indicator is used in an insect trap.

### DETAILED DESCRIPTION OF THE PREFERRED EMBODIMENTS OF THE INVENTION

The present invention comprises a system for determining the effectiveness of a consumable source (2) in a device (1) that uses the consumable source (2) to perform an action of the device.

In the broadest sense, the system comprises a controller (3) for monitoring the consumable source (2) in the device, one or more consumable sources (2) operatively connected to the device (1); sensing means (4) for determining when the consumable source(s) (2) needs replacing; and an indicator (5) operatively coupled to the sensing means (4) that signals when the consumable source(s) (2) needs replacing.

The invention is especially useful in situations where the effectiveness of the consumable source (2) is not discernible by a user. Examples of consumable sources (2) that are not readily discernible by a user include for example light sources (including UV lights), adhesive covered surfaces, and other time related components.

The indicator (5) may be selected from the group consisting of lights and buzzers.

Depending on the consumable source (2), the sensing means generally comprises a timer or a sensor. Other sensing means would also be known to one skilled in the art. In a preferred embodiment, the sensing means is reset when the consumable source is replaced. The resetting can be done either manually (by the user) or automatically (by the controller) depending on the particular application. In a preferred embodiment, the controller comprises a microcontroller. Such microcontrollers are well known to those skilled in the art.

The replacement indicator may be used in any device that contains a consumable source that whose effectiveness over time is not easily discernible. For example, the device may be a hand dryer containing a UV light, such as described in British Patent Application No. 0304825.3, the subject matter of which is herein incorporated by reference in its entirety.

In another embodiment, the device is an insect trap containing a UV light source and an adhesive paper for trapping insects, such as described in U.S. Pat. No. 5,915,948, the subject matter of which is herein incorporated by reference in its entirety. While these two systems are specifically noted, the invention is not limited to these two embodiments. Other systems containing consumable sources that need periodic replacement would also be discernible to those skilled in the art.

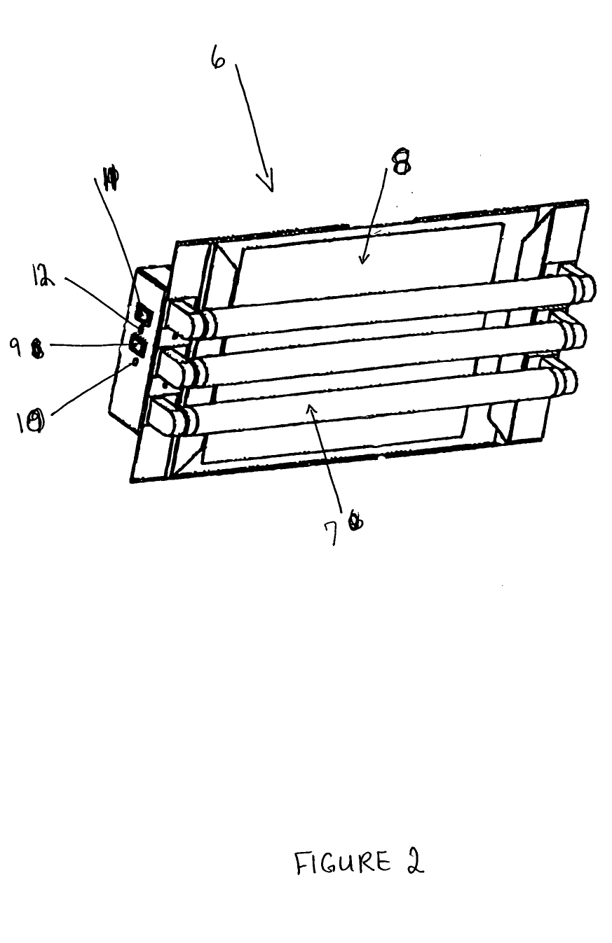

In one embodiment of the invention, as illustrated in FIG. 2, the device comprises a light trap (6) used to attract flying insects, comprising UV tubes (7) to attract insects to the device (6) and a sticky (adhesive) surface (8) for trapping/retaining the insects on the device (6). The device (6) incorporates a resetable timer device (not shown) to indicate when consumable sources fundamental to the efficiency of the device (6) should be replaced.

During operation of the device (6), UV light is emitted from the light source (7) at a wavelength deemed attractive to flying insects. Over the course of time, the level of UV light emitted from the source (6) deteriorates, to a point roughly but not exclusively of 8000 hours of continual use, where so little UV is emitted that the usefulness of the device is negligible. The invention highlights that the period of useful life of the source of UV light has expired and may be indicated by an indicator light (9). In another embodiment, a buzzer or similar device may be used as the indicator device. Replacement sources of UV light (7) should then be installed into the device (6). The invention incorporates a reset function (10), which should be activated to begin the time again.

Similarly, replacement adhesive substrates (8) should be replaced after a period of time to combat the adhesive drying out and/or the adhesive are filling with caught insects. The invention incorporates a second indicator device (11) and timer (12) to indicate when the adhesive substrates (8) should be replaced.

1. A system for determining the effectiveness of a consumable source in a device that uses the consumable source to perform an action of the device, the system comprising:
a controller for monitoring the consumable source in the device;
a consumable source operatively connected to the device;
sensing means for determining when the consumable source needs replacing; and
an indicator operatively coupled to the sensing means that signals when the consumable source needs replacing.

2. The apparatus of claim 1, wherein the consumable source is selected from the group consisting of light sources, adhesive surfaces, and time related components.

3. The apparatus of claim 1, wherein the effectiveness of the consumable source is not discernible by a user.

4. The apparatus of claim 1, wherein the indicator is selected from the group consisting of lights and buzzers.

5. The apparatus of claim 1, wherein the sensing means comprises a timer or a sensor.

6. The apparatus of claim 5, wherein the sensing means is reset when the consumable source is replaced.

7. The apparatus of claim 1, wherein the controller comprises a microcontroller.
